(19) United States
(12) Patent Application Publication
(10) Pub. No.: US 2026/0239000 A1
(43) Pub. Date: Aug. 13, 2026

(54) ACCESS STRATUM KEY HIERARCHY

(71) Applicant: QUALCOMM Incorporated, San Diego, CA (US)

(72) Inventor: Soo Bum LEE, San Diego, CA (US)

(21) Appl. No.: 19/053,360

(22) Filed: Feb. 13, 2025

(51) Int. Cl. H04W 12/0431; H04W 12/041; H04W 12/08

(52) U.S. Cl. CPC H04W 12/0431; H04W 12/041; H04W 12/08

(57) ABSTRACT

An apparatus, method and computer-readable media are disclosed for accessing a wireless network. For example, a process for accessing to a wireless network can include: receiving, by an access stratum (AS) security anchor, a service key request for a set of wireless nodes; generating, based on an AS security anchor key of the AS security anchor, a wireless node key for a wireless node, of the set of wireless nodes; and transmitting the wireless node key to the wireless node, wherein the wireless node key is for establishing a secure connection between the wireless node and a wireless device.

### FIELD

The present disclosure generally relates to wireless communications. For example, aspects of the present disclosure relate to access stratum key hierarchy for a wireless network.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. A sixth-generation (6G) mobile standard may build on 5G to offer further increased data transfer speeds, better coverage, and improved security, among other improvements.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. In one illustrative example, an apparatus for accessing a wireless network is provided. The apparatus includes: a memory system comprising instructions; and a processor system coupled to the memory system, wherein the processor system is configured to: receive, by an access stratum (AS) security anchor, a service key request for a set of wireless nodes; generate, based on an AS security anchor key of the AS security anchor, a wireless node key for a wireless node, of the set of wireless nodes; and transmit the wireless node key to the wireless node, wherein the wireless node key is for establishing a secure connection between the wireless node and a wireless device.

As another example, a method for accessing a wireless network. The method includes: receiving, by an access stratum (AS) security anchor, a service key request for a set of wireless nodes; generating, based on an AS security anchor key of the AS security anchor, a wireless node key for a wireless node, of the set of wireless nodes; and transmitting the wireless node key to the wireless node, wherein the wireless node key is for establishing a secure connection between the wireless node and a wireless device.

In another example, a non-transitory computer-readable medium having stored thereon instructions that, when executed by at least one processor, cause the at least one processor to: receive, by an access stratum (AS) security anchor, a service key request for a set of wireless nodes; generate, based on an AS security anchor key of the AS security anchor, a wireless node key for a wireless node, of the set of wireless nodes; and transmit the wireless node key to the wireless node, wherein the wireless node key is for establishing a secure connection between the wireless node and a wireless device.

As another example, an apparatus for wireless communications comprising means for receiving, by an access stratum (AS) security anchor, a service key request for a set of wireless nodes; means for generating, based on an AS security anchor key of the AS security anchor, a wireless node key for a wireless node, of the set of wireless nodes; and means for transmitting the wireless node key to the wireless node, wherein the wireless node key is for establishing a secure connection between the wireless node and a wireless device.

In another example, an apparatus for accessing a wireless network is provided. The apparatus includes: a memory system comprising instructions; and a processor system coupled to the memory system, wherein the processor system is configured to: receive a wireless node key for a wireless node, of a set of wireless nodes, wherein the wireless node key is generated from an access stratum (AS) security anchor key of the AS security anchor; switch to a target wireless node; and establish a secure connection with the target wireless node based on the wireless node key.

As another example, a method for accessing a wireless network. The method includes: receiving a wireless node key for a wireless node, of a set of wireless nodes, wherein the wireless node key is generated from an access stratum (AS) security anchor key of the AS security anchor; switching to a target wireless node; and establishing a secure connection with the target wireless node based on the wireless node key.

In another example, a non-transitory computer-readable medium having stored thereon instructions that, when executed by at least one processor, cause the at least one processor to: receive a wireless node key for a wireless node, of a set of wireless nodes, wherein the wireless node key is generated from an access stratum (AS) security anchor key of the AS security anchor; switch to a target wireless node; and establish a secure connection with the target wireless node based on the wireless node key.

As another example, an apparatus for wireless communications comprising means for receiving a wireless node key for a wireless node, of a set of wireless nodes, wherein the wireless node key is generated from an access stratum (AS) security anchor key of the AS security anchor; means for switching to a target wireless node; and means for establishing a secure connection with the target wireless node based on the wireless node key.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 is a block diagram illustrating a key hierarchy for a wireless system, in accordance with aspects of the present disclosure;

FIG. 6 is a call flow diagram illustrating a technique for AS security anchor key derivation for a wireless system, in accordance with aspects of the present disclosure;

FIG. 7 is a call flow diagram illustrating a technique for AS security anchor key derivation for a wireless system, in accordance with aspects of the present disclosure;

FIG. 8 is a call flow diagram illustrating a technique for refreshing a wireless node key for a wireless system, in accordance with aspects of the present disclosure;

FIG. 9 is a flow diagram illustrating a process for accessing a wireless system, in accordance with aspects of the present disclosure;

FIG. 10 is a flow diagram illustrating a process for accessing a wireless system, in accordance with aspects of the present disclosure;

FIG. 11 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3^{rd} Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

Various systems and techniques are provided with respect to wireless technologies (e.g., The 3GPP 5G/New Radio (NR) Standard, 6G, etc.) to provide improvements to wireless communications. A device (e.g., a UE, wireless device, mobile device, etc.) can be configured to access a wireless network (e.g., wireless system) to communicate with other devices. As a part of accessing the wireless network, the device may be configured to authenticate with the wireless network. Based on the authentication, the device may establish one or more security contexts to allow for private communications between the device and services of the wireless network. In some wireless networks, a device connecting to the wireless network may establish a security context with a security function of a core network (e.g., non-access stratum (NAS) security). Based on this security context, additional application layer security may be established on top of this security context.

In some cases, access stratum (AS) security may be used to secure a connection between a device and a wireless node of the wireless system that is connected to the device. The wireless node may be a base station, such as a gNB, eNB, CU, etc., through which access to a wireless network may be provided. The AS security may apply a layer of security to a radio interface that connects the device to the wireless node of the wireless system.

In some cases, AS security may be based on a set of cryptographic keys. For example, an AS security context between a wireless node and a wireless device may be based on a wireless node cryptographic key (e.g., wireless node key) shared between the wireless node and the wireless device. The wireless node key may be a cryptographic key that may be used to protect messages between the wireless node and the wireless device. In some wireless systems, when a wireless device has an AS security context with a first wireless node and the wireless device is to be handed over (e.g., switched) from the first wireless node to a second wireless node, the first wireless node may derive a new wireless node key based on the current wireless node key and transmit the new wireless node key to the second wireless node. The AS security context may be established when a scheme for securing communications via encoded messages has been set up between the wireless node and the wireless device. A handover may be when a wireless device stops communicating with one wireless node and starts to communicate with another wireless node. In such cases, the first wireless node may have access to the new wireless node key, which violates key separation and forward security. Key separation may be a cryptographic principle that different cryptographic keys should be used for different nodes/functions/operations. Forward security may be a cryptographic principle where previously encrypted messages are protected if an entity (e.g., nodes/functions/operations) is later compromised.

Additionally, the wireless node keys may be derived based on a cryptographic key of an AS security anchor. In some cases, the AS security anchor may be an entity of the wireless network which holds a root key from which AS security keys, such as wireless node keys, may be derived. In some wireless systems, the AS security anchor may be collocated with a security service, mobility service, access and mobility management function (AMF), and the like. The security service may be a security anchor (e.g., an entity which holds a root key from which other keys may be derived) for the core network. The mobility service may be a service of the wireless network which keeps track of a location and status of a wireless device. In some cases, such as due to wireless device mobility, the AS security anchor may be changed. In such cases, an old AS security anchor may derive a new AS security anchor key based on an old AS security anchor key and transmit the new AS security anchor key to a new AS security anchor, which also violates key separation and forward security. Wireless device mobility may refer to a wireless device moving out of range of a wireless node. The AS security anchor key may be a cryptographic key of the AS security anchor from which wireless node keys may be derived.

Systems, apparatuses, processes (also referred to as methods), and computer-readable media (collectively referred to as “systems and techniques”) are described herein for accessing a wireless network securely without violating key separation and forward security. For example, a mobility service may determine a set of wireless nodes that a wireless device may switch over to. The mobility service may indicate the set of wireless nodes (e.g., central units (CUs) of a disaggregated base station) to an AS security anchor via a service key request. The service key request may be a request to obtain a service key for securing communications between the set of wireless nodes and a wireless device. The service key may be cryptographic key that may be used to encode/decode messages transmitted/received between the wireless nodes and the wireless device. The AS security anchor may receive the service key request and the AS security anchor may generate wireless node keys (e.g., K_{CU}) for wireless nodes of the set of wireless nodes. The wireless node keys may be used for establishing a secure connection (e.g., security context) between a wireless node and the wireless device. The AS security anchor may transmit the generated wireless node keys to the wireless nodes. In some cases, the wireless node keys may be transmitted to wireless nodes in advance of a mobility event from the wireless device. A mobility event may be when a wireless device is indicated (or determines) to change (e.g., handover) from a current wireless node to another wireless node (e.g., target cell, target CU, etc.). For example, wireless devices may be configured to switch from one wireless node to another without being directed by the wireless network and the AS security anchor may prepare the wireless nodes of the set of wireless nodes for such a switch (e.g., handover) by transmitting the wireless node keys to the wireless nodes.

In some cases, the AS security anchor may generate wireless node keys based on an AS security anchor key (K_{CUA}) of the AS security anchor. In some cases, the AS security anchor key may be generated based on a security service key (K_{SecSvc}) of the wireless network. The security service key (K_{SecSvc}) of the wireless network may be a cryptographic key of a security service for a wireless network. The AS security anchor key may be generated based on a set of parameters such as the security service key, an AS security anchor key index, one or more freshness parameters, and an invalidation parameter. A parameter may be an input for a function. The invalidation parameter may be a parameter (e.g., variable, indication, bit, etc.) that indicates whether a current AS security anchor key should be invalidated. The AS security anchor key index may be incremented each time a new AS security anchor key is generated. The AS security anchor key index may be a number which tracks how many times the AS security anchor key has been generated. A current AS security anchor key may be invalidated if the invalidation parameter is set. If the invalidation parameter is not set, the current AS security anchor key may not be invalidated. A freshness parameter may be a number which is changed based on some criteria that allows a function that derives keys to derive a different key. The one or more freshness parameters may include an uplink freshness parameter and a downlink freshness parameter. In some cases, there may be multiple types of freshness parameters and what type of freshness parameter may be used may be based on whether generation of the AS security anchor key is initiated by a wireless device (e.g., via a service request or service activation) or by the wireless network (e.g., via an anchor change, periodic key maintenance, etc.). In some cases, deriving the AS security anchor key based on a set of parameters which do not include information from a current AS security anchor, horizontal key derivation by a current AS security anchor may not be used and key separation and forward security preserved.

In some cases, the wireless node keys are generated based on the AS security anchor key, a key identifier, a channel binding frequency, and one or more freshness parameters. The channel binding frequency (e.g., ARFCN, absolute radio frequency channel number) may be a code which specifies reference frequencies used for transmission and reception in the wireless system and this code may be defined in a specification, such as a 3GPP specification. The key identifier may be based on an identifier for a wireless node concatenated with a wireless node key index. In some cases, a wireless device may be connected with multiple wireless nodes, and the wireless node identifier may help identify which wireless node a wireless node key is associated with. The wireless node key index may be incremented based on establishing a secure connection between the wireless node and the wireless device. In some cases, the wireless node key index may be common to the set of wireless nodes such that establishing a new secure connection between the wireless node and the wireless device causes the wireless node key index to be incremented for all of the wireless nodes of the set of wireless nodes and wireless node keys and wireless node keys based on the current wireless node key index may be invalidated. In some cases, the one or more freshness parameters may include an uplink freshness parameter and a downlink freshness parameter. The uplink freshness parameter may be a freshness parameter that may be used to encode/decode uplink messages. The downlink freshness parameter may be a freshness parameter that may be used to encode/decode downlink messages. In some cases, there may be multiple types of freshness parameters and what type of freshness parameter may be used may be based on a connection state (e.g., RRC state, such as idle, inactive, connected, etc.) of the wireless device.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

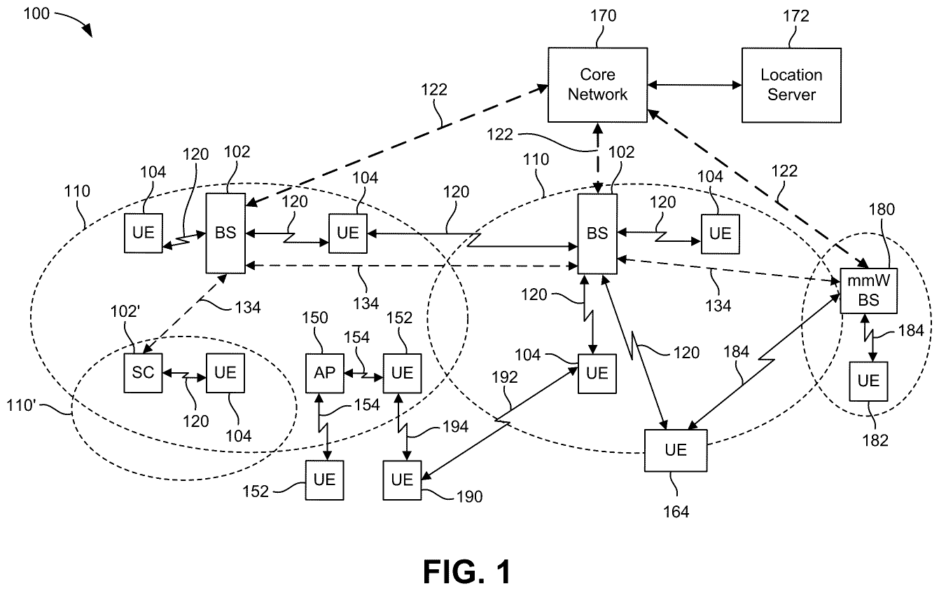

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’without interrupting the service on band ‘X’or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

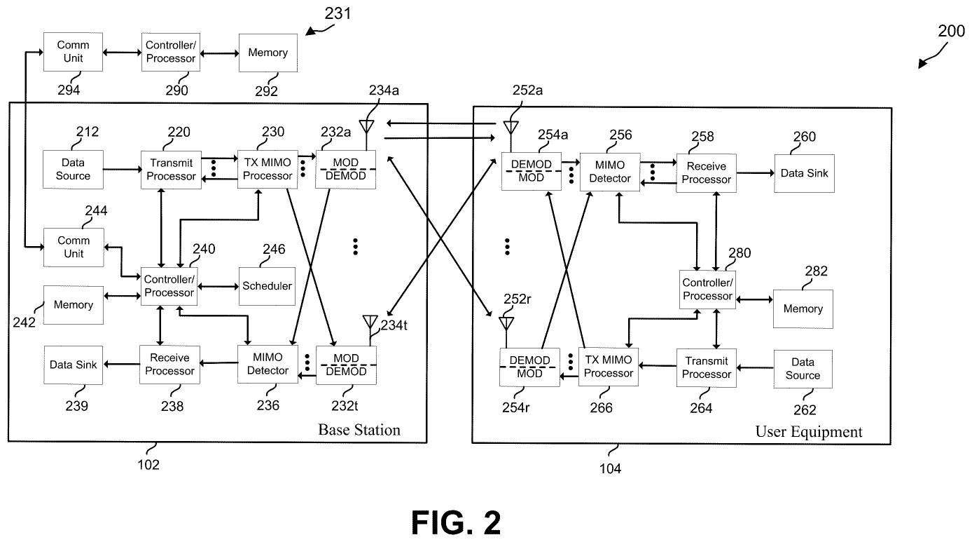

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit uplink control information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

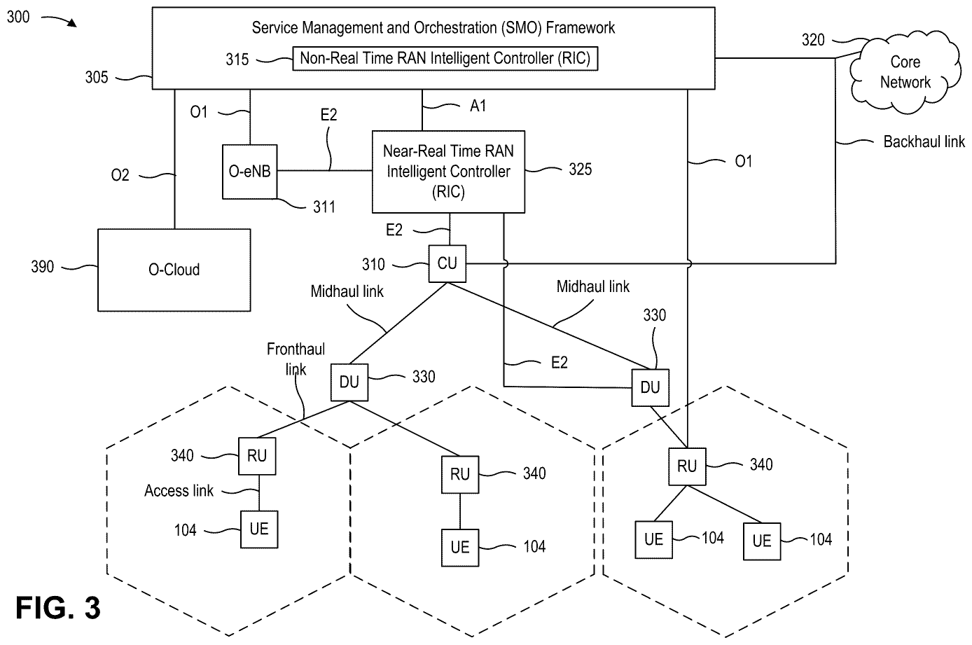

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

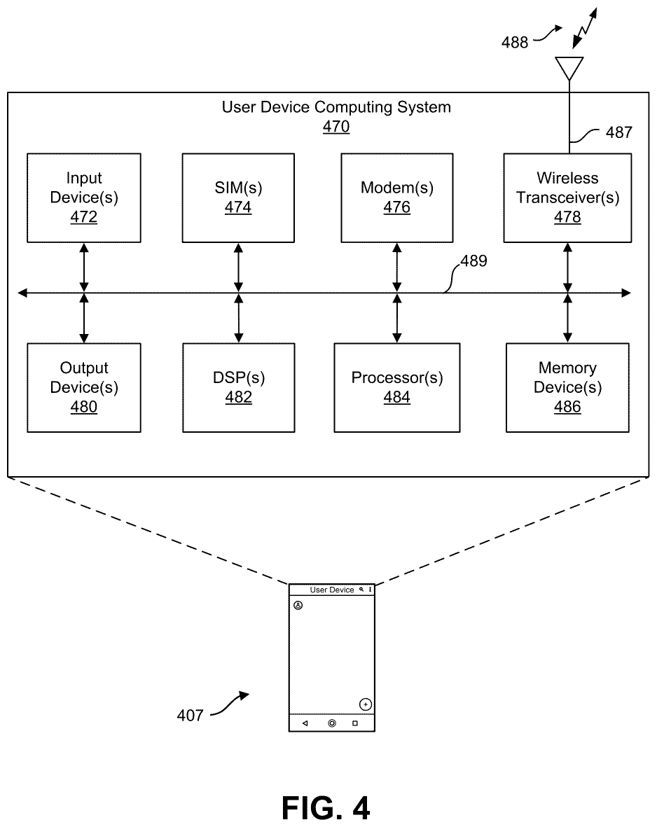

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

In some wireless systems, multiple security contexts exist on a layer basis and multiple services may exist with a single security context. For example, a security context (that is a result of an authentication procedure to establish cryptographically secured communication between two elements) may be established between a mobile device, such as a UE, and a core network (e.g., a non-access stratum (NAS) security context between a UE and an access and mobility management function (AMF) of the core network, such as core network 320 of FIG. 3). This NAS security context may anchor other security contexts as other security contexts may build on the NAS security context. The security contexts may be established using cryptographic keys (e.g., keys or key). In some cases, multiple cryptographic keys may be derived from a session root key. For example, an authentication server function (AUSF) of a core network may include a session root key (K_{AUSF}). In some cases, a cryptographic key for an AMF may be derived based on the session root key (K_{AUSF}). As an example, a security anchor function key (K_{SEAF}) may be derived from the session root key (K_{AUSF}), and from the security anchor function key (K_{SEAF}), an AMF key (K_{AMF}) may be derived. In some cases, to establish a security context between the AMF and a wireless node, such as a gNB, eNB, CU, etc., a wireless node key (K_{gNB} (e.g., K_{eNB}, K_{CU}, etc.)) may be derived from the AMF key (K_{AMF}).

In some cases, such as due to mobility of a UE, an AMF switch (e.g., AMF relocation) may be performed. In such cases, a new AMF key (K_{AMF2}) may be derived for the new AMF. However, this new AMF key (K_{AMF2}) may be derived from old AMF key (K_{AMF1}) (e.g., using horizontal key derivation) by the old AMF, which violates key separation and forward security.

Additionally, when a CU/eNB/gNB change-over is performed, an old CU/eNB/gNB may also derive a new wireless node key for a new CU/eNB/gNB, which also violates key separation and forward security. In some cases, a new wireless node key may be derived for a new CU/eNB/gNB based on the AMF key for AS security, but this may be performed using an intra CU/eNB/gNB handover procedure, which may include additional signaling with the UE. Further, the UE cannot maintain multiple AS security contexts due to AS key derivation and/or separation rules. For example, maintaining two AS security contexts anchored at different CUs, eNBs, gNBs, etc., may not be supported. In some cases, a more flexible key hierarchy supporting key separation and multiple key anchors (e.g., for multiple concurrent AS security contexts) may be useful. Of note, while operations discussed herein are in context with a CU, it should be understood that the operations discussed herein are applicable to DUs as well, for example, for use with a converged radio access network and core network (RAN-CN) architecture.

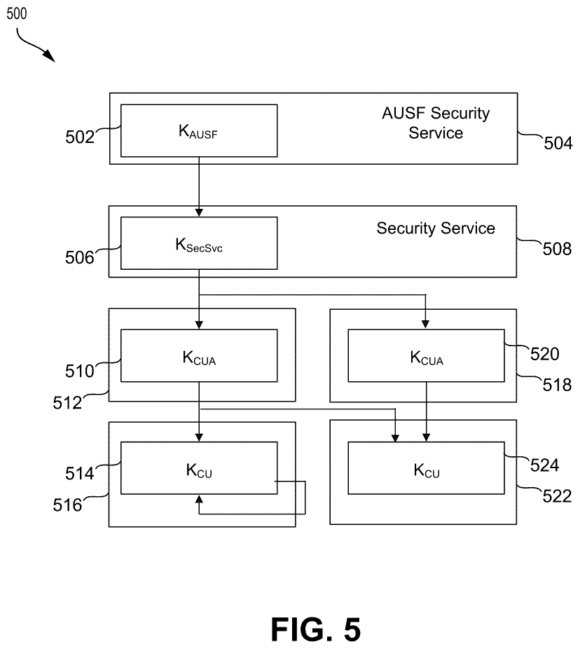

FIG. 5 is a block diagram illustrating a key hierarchy 500 for a wireless system, such as wireless communications network 100, in accordance with aspects of the present disclosure. In the key hierarchy 500, a session root key 502 (K_{AUSF}) may be established by a security service for the AUSF 504. A security service key 506 (K_{SecSvc}) for a security service 508 of the core network may be derived from the session root key 502 using vertical key derivation. In some cases, the security service 508 may be a security anchor (e.g., an entity which holds a root key from which other keys may be derived) for the core network. In some cases, the security service 508 may be replaced by a mobility service and/or an AMF. A first AS security anchor key 510 (K_{CUA}) may be derived from the security service key 506 for a first security service or AS security anchor 512, such as a mobility service or AMF, or any other entity that holds the anchor key for the wireless node. From the first AS security anchor key 510, a first wireless node key 514 (K_{CU}) (e.g., AS key) may be derived for a first CU 516.

In some cases, when a security service or AS security anchor switch is performed a vertical key derivation may be performed, as compared to the horizontal key derivation where the new key is derived from the current key. For example, when switching to a second security service or AS security anchor 518, a second AS security anchor key 520 (K_{CUA}) may be derived from the security service key 506. Similarly, for a RAN and AS security, when a CU change-over from the first CU 516 to a second CU 522 is performed, a second wireless node key 524 (K_{CU}) may be vertically derived from either the first AS security anchor key 510 (K_{CUA}) or the second AS security anchor key 520 (K_{CUA}). For example, on handover, the first CU 516 may indicate that it intends to handover a UE to the second CU 522 to the first security service or AS security anchor 512. The first security service or AS security anchor 512 may, in response to the indication to handover the UE, derive the second wireless node key 524 (K_{CU}) and transmit the second wireless node key 524 (K_{CU}) to the second CU 522 to prepare the second CU 522 for the handover.

As another example, on handover, the first CU 516 may indicate, to the second CU 522, that it intends to handover a UE to the second CU 522. The second CU 522 may then request, in response to the indication to handover the UE, the second wireless node key 524 (K_{CU}) from the first security service or AS security anchor 512.

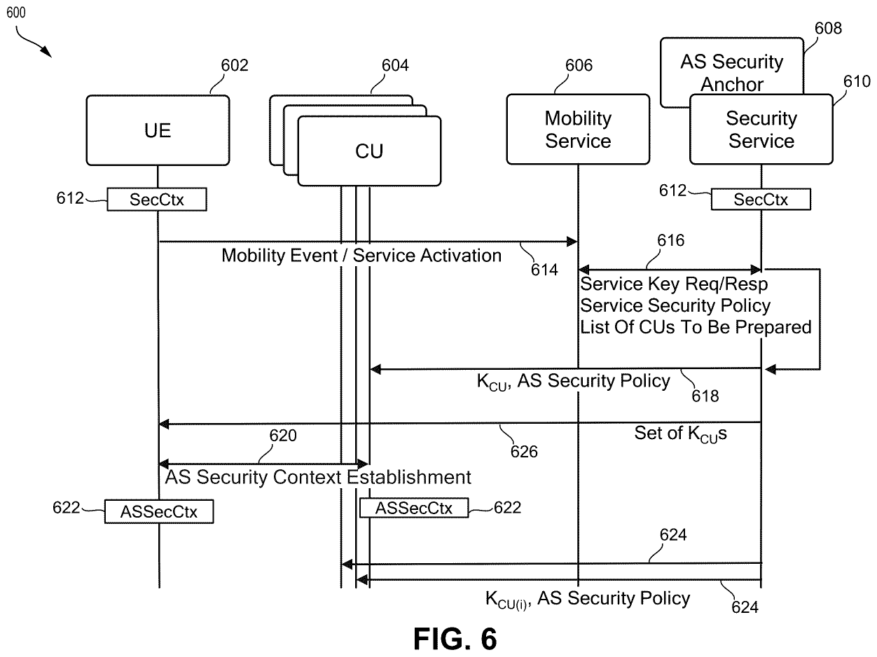

FIG. 6 is a call flow diagram illustrating a technique for AS security anchor key derivation 600 for a wireless system, in accordance with aspects of the present disclosure. The wireless system illustrated in FIG. 6 includes a UE 602 (e.g., wireless device), a set of CUs 604 (e.g., DU, eNB, gNB, wireless node, etc.), a mobility service 606, and an AS security anchor 608. In this example, the AS security anchor is collocated at a security service 610. The UE 602 may be substantially similar to UE 104 of FIGS. 1-3, UE 152 of FIG. 1, UE 164 of FIG. 1, UE 182 of FIG. 1, wireless device 407 of FIG. 4, etc.), the CUs 604 may be substantially similar to base station 102 of FIGS. 1-2, CU 310 of FIG. 3, first CU 516 of FIG. 5 second CU 522 of FIG. 5, etc., and the AS security anchor 608 may be substantially similar to AS security anchors 512, 518 of FIG. 5.

In some cases, an AS security anchor 608 may be collocated with a security service 610 or mobility service 606. In some cases, the AS security anchor 608 may be a separate entity in the core network. In some cases, the AS security anchor 608 may be located at a CP-CU or mobility service 606, depending on a RAN/CN architecture and/or deployment. The AS security anchor 608 may be an entity (e.g., a logical function) which helps provides AS security between the wireless device and a RAN of the wireless network, as well as security between the RAN and a core network of the wireless network. For example, the AS security anchor 608 may provide an AS key, such as K_{CU}, to a CU (e.g., of the set of CUs 604) on the RAN side, and the CU may use the AS key to establish a security context between the CU and the UE 602.

In some cases, the security service 610 may provide security services for wireless devices along with other network functions. For example, the security service 610 may help establish security contexts (e.g., establish authentication keys) as between other services and the wireless devices.

The mobility service 606 may monitor the movement of the UE 602 to determine the set of CUs 604 (or other wireless nodes) the UE 602 may move to. In some cases, the mobility service 606 may be similar to an AMF, such as a 6G AMF.

In some cases, the UE 602 may have an established security context 612 with the security service 610. For example, the UE 602 may establish the security context 612 with the security service 610 based on a service access request sent to the security service 610 by the UE 602 and an authentication and key agreement procedure. The security context 612 may be based on a security service key (K_{SecSvc}). The security service key (K_{SecSvc}) may be substantially similar to security service key 506 (K_{SecSvc}) of FIG. 5.

In some cases, the UE 602 may be mobile and the UE 602 may transmit an indication of a mobility event and/or mobility service activation indication 614 to the mobility service 606. Based on the received indication, the mobility service 606 may determine the set of CUs 604 that the UE 602 may be handed off to. Based on the determined set of CUs 604, the mobility service may may transmit a service key request including an indication of the set of CUs 604, along with information about a current CU serving the UE 602, and possibly service security policy information to the AS security anchor 608 (collocated with the security service 610) as a part of a service key request 616.

The AS security anchor 608 may, in response to the service key request 616, derive wireless node keys (K_{CU}) for the CUs of the set of CUs 604. For example, the AS security anchor 608 may derive a first wireless node key (K_{CU}) for a first CU and transmit 618 the first wireless node key (K_{CU}) to a first CU, of the set of CUs 604. In some cases, the AS security anchor 608 may also transmit 618 AS security policy information to the first CU. If mobility is triggered and the UE 602 switches (e.g., hands over) to the first CU, the UE 602 may establish 620 an AS security context 622 between the UE 602 and the first CU based on the first wireless node key (K_{CU}). The AS security anchor 608 may also derive and transmit 624 additional wireless node keys (K_{CU(i)}) (and possibly AS security policy information) to other CUs of the set of CUs 604. In some cases, wireless node keys may be provided in advance of a mobility event where the UE 602 is switching CUs, or the wireless node keys may be provided on demand. To preserve security, each wireless node key may be independently derived from an AS security anchor key of the AS security anchor 608.

In some cases, the AS security anchor 608 may also provide a set of key derivation parameters for different wireless node keys (K_{CU}s) (e.g., a first set of key derivation parameter for a first wireless node and a second set of key derivation parameters for a second wireless node) to the UE 602, for example, using RRC signaling. The UE 602 may store the set of key derivation parameters for the wireless nodes to derive the corresponding wireless node keys (K_{CU}s) for use, for example, when switching over (e.g., handing over) to a CU 604 (e.g., target CU). For example, the UE 602 may obtain an indication of a hand over (e.g., from the wireless network or based on determination by the UE 602 to switch over) to the target CU and the UE 602 may use a corresponding wireless node key (K_{CU}), such as the first wireless node key (K_{CU}), to communicate with the target CU.

As indicated above, the AS security anchor key (K_{CUA}) may be derived based on the security service key (K_{SecSvc}). In some cases, the AS security anchor key (K_{CUA}) may be derived using a key derivation function (KDF). The KDF may be a cryptographic algorithm that generates one or more keys based on an input key. In some cases, the derivation of the AS security anchor may be expressed as K_{CUA}=KDF(K_{SECSVC}, KId, FP_{UL}, FP_{DL}, INV), where KId may be an identifier representing a K_{CUA} index, where FP_{UL} and FP_{DL} represent freshness parameters, and where INV represents an invalidation parameter.

In some cases, the KId may be a K_{CUA} index which identifies the AS security anchor 608, as there may be multiple AS security anchors. In some cases, the KId may be an index number (e.g., AS security anchor key index) which may be incremented each time a new AS security anchor key (K_{CUA}) is derived (e.g., generated, assigned, etc.). In some cases, the KId may be incremented if the AS security anchor 608 is changed (e.g., due to UE 602 mobility, establishing security context with multiple AS security anchors, etc.). In some cases, when the KId is incremented, a current AS security anchor key (K_{CUA}), along with all of the children keys of the current AS security anchor key, may be invalidated. For example, if the INV (invalidation) parameter is set, then the current AS security anchor key (K_{CUA}), along with all of the children keys of the current AS security anchor key, may be invalidated. If the INV parameter is not set, then the current AS security anchor key (K_{CUA}) may be considered still valid. Allowing a current AS security anchor key to remain valid may allow for multiple CUA holders (e.g., where multiple AS security anchors are located in multiple locations, such as for dual connectivity) to be supported. How many multiple CUA holders may be supported may be based on a configuration of the wireless network. In some cases, a CUA may correspond to a particular PLMN, registration area, tracking area, RAN notification area, etc., which should be signaled to the UE 602.

In some cases, FP_{UL} may represent an uplink freshness parameter sent from the UE 602 to the wireless network for key derivation, and FP_{DL} may represent a downlink freshness parameter sent from the wireless network to the UE 602. In some cases, to support different scenarios, the uplink freshness parameter and/or the downlink freshness parameter may support multiple freshness parameter types. In some cases, the freshness parameter types supported may include a constant type, a nonce type, and a current key type. In some cases, the constant type (e.g., type 0) may have a constant value or fixed value and the constant type may be used where there is no uplink message. In some examples, a constant type freshness parameter, as they may have a constant or fixed value (or null), the constant type freshness parameter may be known in advance and the constant type freshness parameter may not have to be transmitted as parameters in a downlink/uplink message. In some cases, the constant type may be skipped for key derivation as they may not contribute to input entropy. The nonce type (e.g., type 1) may be a value that may be randomly generated by the UE 602. In some cases, the current key type (e.g., type 2) may indicate that a current key may be used as a freshness parameter for deriving a next key (e.g., next K_{CUA}). In some cases, the current key type may be used when an AS security anchor 608 is not being changed, but the AS security anchor key is being refreshed.

In some cases, the AS security anchor key derivation (e.g., rekeying, rederivation, etc.) may be triggered by the wireless network or the UE 602. In some cases, wireless network triggered AS security anchor key derivation (e.g., network initiated derivation) may be performed, for example, for handover of the UE 602 (e.g., AS anchor change), periodic maintenance (e.g., refreshing the AS security anchor key without changing the RAN node), due to a K_{SECSVC} change (e.g., due to new authentication with the security service 610), counter value wrap-around, and the like. In some case, for the network initiated derivation, the FP_{UL} may be a constant type as the derivation is network initiated and there may not be an uplink message from the UE 602 initiating the AS security anchor key derivation. In some cases, for the network initiated derivation, the FP_{UL} may be a current key type. For example, the wireless network may indicate that the current key may be used as a freshness parameter for deriving a next key (e.g., next K_{CUA}) using the FP_{UL} freshness parameter type. In some cases, the FP_{DL}, for the network initiated derivation, may be a nonce type where a nonce value may be generated by the AS security anchor 608. The nonce value may be used to derive the next AS security anchor key and the AS security anchor 608 may send the nonce value to the UE 602 to allow the UE 602 to derive the next AS anchor key.

In some cases, UE triggered AS security anchor key derivation (e.g., UE initiated derivation) may be performed. In some cases, UE initiated derivation may be performed, for example, when initiating service and/or activating the service (e.g., via a service request). For example, the UE 602 may be connected to the wireless network in an idle connection state and then the UE 602 may initiate AS security using, for example, a service request sent to the AS security anchor 608 or the security service 610. In some cases, for the UE initiated derivation, the FP_{UL} may be a nonce type where the nonce value is randomly generated by the UE as the UE is initiating the derivation. In such cases, the AS security anchor key may be derived based on the nonce value. In some cases, the FP_{DL} may be a nonce type where the nonce value is randomly generated by the AS security anchor 608. For example, the network may generate a value (e.g., nonce value) for the FP_{DL} and signal the value in a service subset message. In some cases, the AS security anchor key may then be derived based on the FP_{UL} value and the FP_{DL} value.

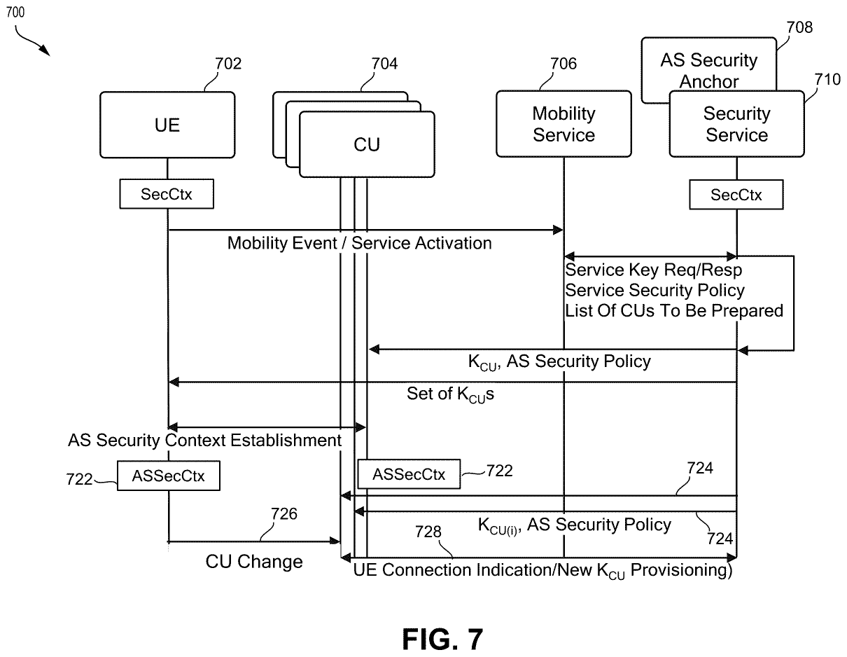

FIG. 7 is a call flow diagram illustrating a technique for AS security anchor key derivation 700 for a wireless system, in accordance with aspects of the present disclosure. The wireless system illustrated in FIG. 7 is substantially similar to the wireless system illustrated in FIG. 6 and includes a UE 702 (e.g., wireless device), a set of CUs 704 (e.g., DU, eNB, gNB, wireless node, etc.), a mobility service 706, and an AS security anchor 708 collocated at a security service 710. The UE 702 corresponds with UE 602 of FIG. 6, the set of CUs 704 corresponds with the set of CUs 604 of FIG. 6, the mobility service 706 corresponds with the mobility service 606 of FIG. 6, the AS security anchor 708 corresponds with the AS security anchor 608 of FIG. 6, and the security service 710 corresponds with security service 610 of FIG. 6.

In FIG. 7, after establishing an AS security context 722 between the UE 702 and a first CU of the set of CUs 704 based on the first wireless node key (K_{CU}) (which is performed in a manner substantially similar to that described with respect to FIG. 6), the UE 702 may switch (e.g., handover) to a second CU of the set of CUs 704. In a manner similar to that described above with respect to FIG. 6, the AS security anchor 708 may derive and transmit 724 additional wireless node keys (K_{CU(i)}) (and possibly AS security policy information) to other CUs (including the second CU) of the set of CUs 704. In some cases, the UE 702 may determine to switch to the second CU. In some cases, the determination to switch to the second CU may be based on a received indication to switch to the second CU. In some cases, the UE 702 may receive an indication of the set of CUs 704 and the UE 702 may determine to switch to the second CU absent explicit signaling to perform the handover from the wireless network. Based on the determination to switch to the second CU, the UE 702 may send an indication 726 of the handover (e.g., handover request) to the second CU. The second CU may then send a UE connection indication 728 to the AS security anchor 708 indicating that the UE 702 has switched to the second CU. In some cases, the second CU may also indicate to the AS security anchor 708 that a new wireless node key (K_{CU}) is being provisioned for the UE 702 (e.g., using the wireless node keys (K_{CU}) for the second CU as a root key) to establish an AS security context between the UE 702 and the second CU.

In some cases, the second CU may derive a new wireless node key (K_{CU}) for the UE 702 to establish the AS security context between the UE 702 and the second CU. In some cases, the derivation of the wireless node key (K_{CU}) may be based on a KDF. The derivation of the wireless node key (K_{CU}) may be expressed as K_{CU}=KDF(K_{CUA}, KId, ARFCN, FP_{UL}, FP_{DL}), where KId may be an identifier, where FP_{UL} and FP_{DL} represent freshness parameters, and where ARFCN represents a frequency for channel binding.

In some cases, as there may be multiple CUs to which the UE 702 can connect to and each CU may be associated with multiple wireless node keys, each wireless node key may be associated with a unique identifier, such as key identifier KId, so that the UE 702 and elements of the wireless network can identify a specific wireless node key. In some cases, the KId may be CU identifier concatenated with a K_{CU} index. The CU identifier may be an identifier associated with the CU being connected to (e.g., handed over to, such as the second CU). The K_{CU} index may identify a key that may be used for the CU being connected to as multiple wireless node keys may be derived for a same CU. In some cases, the K_{CU} index may be incremented for each wireless node key that is derived. For example, if the UE 702 is connected to a first CU using an initial wireless node key is switched over to the second CU and then switched back to the first CU, the K_{CU} index allows a new wireless node key to be derived for the first CU after the second switch-over, as compared to the initial wireless node key (e.g., without a new K_{CUA} key being derived/refreshed).

In some cases, including the frequency for channel binding (e.g., channel binding frequency) for deriving the wireless node key allows the wireless node key to be bound to a single cell (e.g., CU/DU/eNB/gNB/etc.) to help avoid, for example, man in the middle attacks.

In some cases, a new wireless node key may be derived when the UE is in a connected state, or when there is a state transition. In some cases, a freshness parameter type for the uplink freshness parameter FP_{UL} and/or downlink freshness parameter FP_{DL} may be determined based on whether the wireless node key is being derived when the UE is in a connected state or based on a state transition. A new wireless node key may be derived when the UE 702 is in a connected state, for example, for inter-CU mobility, radio link failure (RLF) recovery (e.g., to another CU), key refresh, and the like. In some cases, where the new wireless node key is derived when in a connected state, the FP_{UL} may be a constant type as the derivation of the new wireless node may not be UE 702 initiated. In some cases, where the new wireless node key is derived when in a connected state, the FP_{DL} may also be a constant type as the K_{CU} index may allow for a new wireless node key to be derived without having to rely on the freshness parameters.

In some cases, the K_{CU} index may be incremented (e.g., by 1) for the CU after a successful AS security setup (e.g., establishing an AS security context, such as AS security context 722, between the UE 702 and the CU). Incrementing the K_{CU} index after a successful AS security setup helps ensures a fresh wireless node key is derived for a next wireless node key, for example, if the UE switches to another CU and then switches back. In some cases, if AS security setup is initiated with a lower K_{CU} index as compared to the K_{CU} index stored by the UE for a CU (or stored by a CU for the UE), then the AS security setup may be rejected. Rejecting a AS security setup with a lower K_{CU} index have help avoid replay attacks.

In some cases, the UE may provide the K_{CU} index to a target CU to help avoid potential desynchronization issues. In some cases, the K_{CU} index may be provided by the UE in the indication 726 of the handover. In some cases, the CU may obtain a current wireless node key (K_{CU}) from the AS security anchor 708, for example, if the CU is not prepared (e.g., not a part of the set of CUs 704) with a derived wireless node key (e.g., where the CU did not receive a wireless node key from the AS security anchor 708). In some cases, the CU may obtain the wireless node key from the AS security anchor 708 via the UE connection indication 728. The CU may also request a refreshed wireless node key from the AS security anchor 708 using an AS security mode command (AS SMC). To obtain the wireless node key from the AS security anchor 708, the CU may provide the AS security anchor 708 information about the UE 702. In some cases, the information about the UE 702 may be obtained by the CU from a current CU (e.g., CU the UE 702 is switching from). In some examples, the information about the UE 702 may be obtained by the CU from the UE 702, such as the indication 726 of the handover. The information about the UE may be UE identification information other than a C-RNTI. For example, the C-RNTI may be CU and/or cell specific and some other identifier may be used for the UE identification information to identify the UE's AS security context as the AS security anchor 708. In some cases, the K_{CU} index for deriving a new K_{CU} may be maintained by the CU and/or the AS security anchor 708.

In some cases, a freshness parameter type for the uplink freshness parameter FP_{UL} and/or downlink freshness parameter FP_{DL} for deriving a wireless node key may be determined based on a state transition of the wireless node. A state transition may be a change in a state of a UE 702, such as when the UE 702 transitions from an idle and/or inactive connection state to a connected connection state. In some cases, as a part of the state transmission a new wireless node key may be derived. For deriving a new wireless node key as a part of a state transition, the uplink freshness parameter may be a nonce type with a nonce value generated by the UE 702. In some cases, a same nonce value for the uplink freshness parameter may be used for deriving the wireless node key and for deriving the AS anchor key. The downlink freshness parameter may be a nonce type where the nonce value is generated by the CU.

As indicated above, the K_{CU} index may be incremented for each wireless node key that is derived by a CU. In some cases, rather than being CU specific, the K_{CU} index may be common to all CUs of the set of CUs 704. For example, when a new wireless node key K_{CU} is derived from the AS security anchor key (K_{CUA}), the K_{CU} index may be incremented and all of the wireless node keys of all of the CUs associated with the current K_{CU} index may be invalidated. The AS security anchor 708 may generate new wireless node keys (K_{CU}) for the set of CUs 704 after the invalidation. In some cases, signaling from the AS security anchor 708 may be increased when all of the wireless node keys associated with the current K_{CU} index are invalidated, but K_{CU} index management as between the AS security anchor 708 and the UE 702 may be simplified as only a single K_{CU} index can be stored for all of the CUs instead of separate K_{CU} indexes for the CUs of the set of CUs 704.

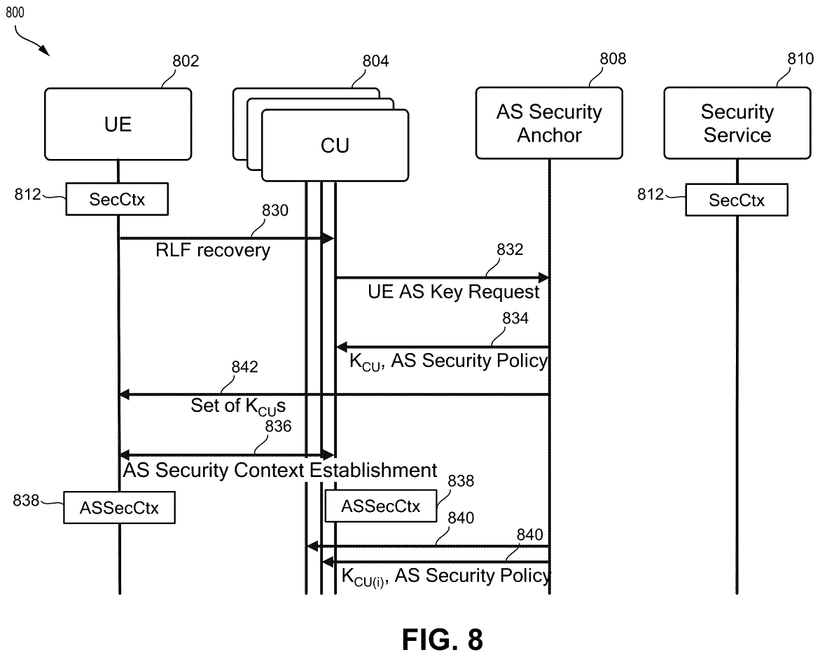

FIG. 8 is a call flow diagram illustrating a technique for refreshing a wireless node key 800 for a wireless system, in accordance with aspects of the present disclosure. The wireless system illustrated in FIG. 8 is substantially similar to the wireless systems illustrated in FIG. 6 and FIG. 7. The wireless system in FIG. 8 includes a UE 802 (e.g., wireless device), a set of CUs 804 (e.g., DU, eNB, gNB, wireless node, etc.), an AS security anchor 808, and a security service 810. The UE 802 corresponds with UE 602 of FIG. 6 and UE 702 of FIG. 7, the set of CUs 804 corresponds with the set of CUs 604 of FIG. 6 and set of CUs 704 of FIG. 7, the AS security anchor 808 corresponds with the AS security anchor 608 of FIG. 6 and the AS security anchor 708 of FIG. 7, and the security service 810 corresponds with security service 610 of FIG. 6 and the security service 710 of FIG. 7. In FIG. 8, the AS security anchor 808 is separate from the security service 810.

In some cases, it may be useful to refresh a wireless node key of a CU, of the set of CUs 804. For example, the wireless node key of the CU may be refreshed in case there is an RLF recovery. In FIG. 8, a security context 812 may be established as between the UE 802 and the security service 810. The security context 812 may be established in a manner substantially similar to that discussed above with respect to FIG. 6. In some cases, the UE 802 may have a RLF with respect to the CU and the UE 802 may perform an RLF recovery 830. For example, the UE 802 may perform a random access procedure and reconnect with the CU after an RLF. Based on the RLF recover 830, the CU may request a refreshed wireless node key 832 (e.g., UE AS key) from the AS security anchor 808. The AS security anchor 808 may respond by transmitting 834 a new wireless node key (K_{CU}). The AS security anchor 808 may also transmit a set of wireless node keys (K_{CU}s) to the UE 802, for example, via RRC signaling. The AS security anchor 808 may also transmit 834 AS security policy information to the CU. Based on the new wireless node key, the CU and the UE 802 may establish 836 a new AS security context 838. In some cases, the AS security anchor 808 may refresh a set of additional wireless node keys (K_{CU(i)}) for the other CUs in the set of CUs 804 and transmit 840 the additional wireless node keys (K_{CU(i)}) (and possibly AS security policy information) to other CUs of the set of CUs 804.

In some cases, the CU may derive a new wireless node key (K_{CU}) for the UE 802 based on the RLF recovery 830. In some cases, the derivation of the wireless node key (K_{CU}) may be based on a KDF. The derivation of the wireless node key (K_{CU}) may be similar to that described above with respect to FIG. 7 and expressed as K_{CU}=KDF(K_{CUA}, KId, ARFCN, FP_{UL}, FP_{DL}), where KId may be an identifier, where FP_{UL} and FP_{DL} represent freshness parameters, and where ARFCN represents a frequency for channel binding.

As discussed above, the KId may be CU identifier concatenated with a K_{CU} index. Where the wireless node key is being refreshed and the CU is not changed, the CU identifier, which identifies the CU the UE 702 is connected to, remains the same. The K_{CU} index may identify a key that may be used for the CU being connected to, and the K_{CU} index may remain the same as the CU is not being changed. In some cases, the uplink freshness parameter when the wireless node key is being refresh may be a nonce type with a nonce value. The downlink freshness parameter may be a current key type with a value set to a current wireless node key (e.g., the wireless node key being refreshed). Including the current wireless node key in the downlink freshness parameter allows a new wireless node key to be generated. In some cases, the UE 802 may be provided with the K_{CU} index using an RRC message from the CU.

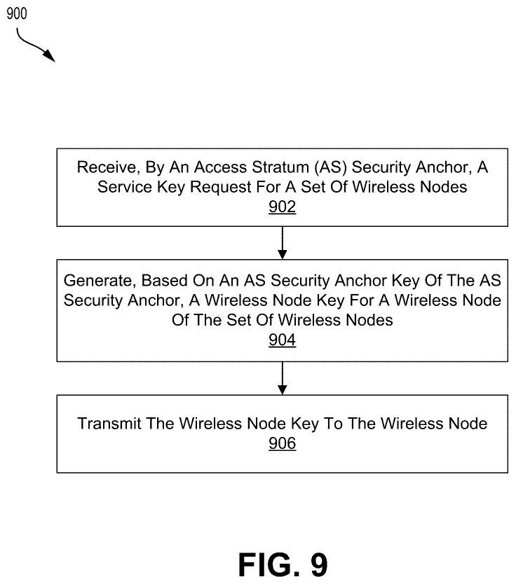

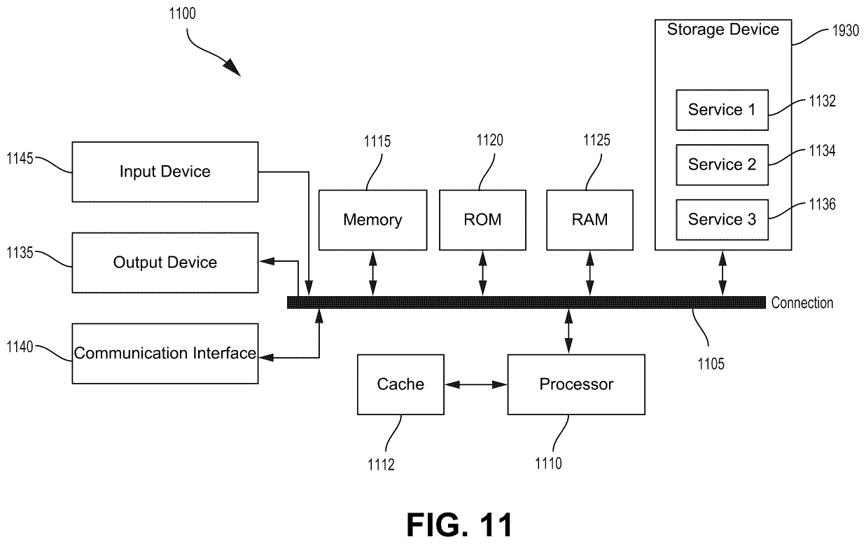

FIG. 9 is a flow diagram illustrating a process 900 for accessing a wireless system, in accordance with aspects of the present disclosure. The process 900 can be performed by a component or system (e.g., a chipset, server, device, etc.) of a wireless network (e.g., BS 102, mmW BS 180, core network 170 of FIG. 1, core network 320 of FIG. 3, SMO Framework 305 of FIG. 3, O-eNB 311 of FIG. 3, RIC 325 of FIG. 3, O-Cloud 390 of FIG. 3, CU 310 of FIG. 3, DU 330 of FIG. 3, AS security anchor 512, 518 of FIG. 5, AS security anchor 608 of FIG. 6, AS security anchor 708 of FIG. 7, AS security anchor 808 of FIG. 8, computing system 1100 of FIG. 11, etc.). The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device (e.g., UE 104, of FIGS. 1 and 2, respectively, wireless device 407 of FIG. 4, UE 602 of FIG. 6, UE 702 of FIG. 7, UE 802 of FIG. 8, computing system 1100 of FIG. 11, etc.). The operations of the process 900 may be implemented as software components that are executed and run on one or more processors (e.g., processor 1110 of FIG. 11 or other processor(s)). Further, the transmission and reception of signals by the wireless network (or component of the wireless network, such as the security service) in the process 900 may be enabled, for example, by one or more antennas (e.g., antennas 234 of FIG. 2) and/or one or more transceivers (e.g., modulators/demodulators 232, TX MIMO processor 230, MIMO detector 236, transmit processor 220, receive processor 238 of FIG. 2, etc.).

At block 902, the computing device (or component thereof) may receive, by an access stratum (AS) security anchor (e.g., AS security anchor 608, which may be collocated with the security service 610 of FIG. 6, AS security anchor 708, which may be collocated with the security service 710 of FIG. 7, AS security anchor 808 of FIG. 8, etc.), a service key request (e.g., service key request 616 of FIG. 6, request for a refreshed wireless node key 832 of FIG. 8) for a set of wireless nodes.

At block 904, the computing device (or component thereof) may generate, based on an AS security anchor key (e.g., AS security anchor key 510 (K_{CUA}), AS security anchor key 520 (K_{CUA}) of FIG. 5, etc.) of the AS security anchor, a wireless node key (e.g., wireless node key 514 (K_{CU}), wireless node key 524 (K_{CU}) of FIG. 5, etc.) for a wireless node, of the set of wireless nodes. For example, the AS security anchor may derive a first wireless node key (K_{CU}) for a first wireless node (e.g., first CU). In some cases, the AS security anchor key is generated based on a security service key (e.g., security service key 506 (K_{SecSvc})) of a security service (e.g., security service 508 of FIG. 5, security service 610 of FIG. 6, security service 710 of FIG. 7, security service 810 of FIG. 8) of the wireless network. In some examples, the AS security anchor key is further generated based on an AS security anchor key index, a freshness parameter, and an invalidation parameter. In some cases, the AS security anchor key index is incremented in response to the generation of the AS security anchor key. In some examples, the freshness parameter comprises at least one of an uplink freshness parameter or a downlink freshness parameter, and wherein a type of the freshness parameter is based on whether generation of the AS security anchor key is initiated by a wireless device or by the wireless network. In some cases, the at least one of the uplink freshness parameter or downlink freshness parameter is based on a fixed value. In some examples, the type of the freshness parameter is further based on a connection state of the wireless device. In some cases, the wireless node key is further generated based on a key identifier, a channel binding frequency, and a freshness parameter. In some cases, the key identifier comprises an identifier for a wireless node concatenated with a wireless node key index, and wherein the wireless node key index is incremented based on establishing the secure connection between the wireless node and the wireless device. In some examples, the wireless node key index is incremented for the set of wireless nodes based on establishing the secure connection between the wireless node and the wireless device.

At block 906, the computing device (or component thereof) may transmit (e.g., transmit 618 of FIG. 6, transmit 834 of FIG. 8, etc.) the wireless node key to the wireless node, wherein the wireless node key is for establishing a secure connection (e.g., establishing 620 AS security context 622 of FIG. 7, establishing AS security context 722 of FIG. 7, establishing 836 AS security context 838 of FIG. 8, etc.) between the wireless node and a wireless device. In some cases, the wireless node key is transmitted to the wireless node in advance of a mobility event from the wireless device. For example, wireless node keys may be provided to CUs of the set of CUs in advance of a mobility event where the UE is switching CUs, or the wireless node keys may be provided on demand.

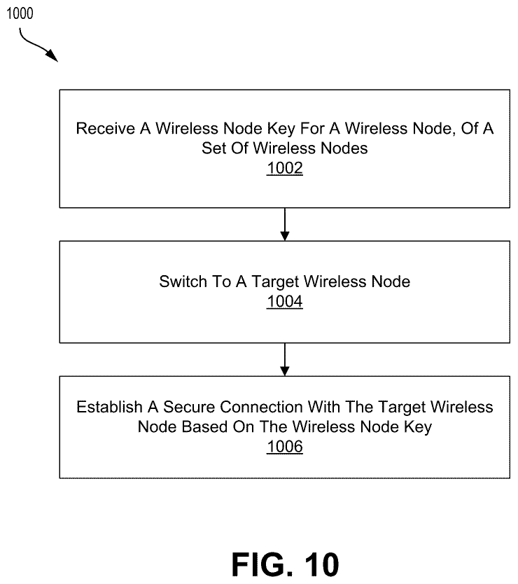

FIG. 10 is a flow diagram illustrating a process 1000 for accessing a wireless system, in accordance with aspects of the present disclosure. The process 1000 can be performed by a component or system (e.g., a chipset, server, device, etc.) of a computing device (e.g., UE 104, of FIGS. 1 and 2, respectively, wireless device 407 of FIG. 4, UE 602 of FIG. 6, UE 702 of FIG. 7, UE 802 of FIG. 8, computing system 1100 of FIG. 11, etc.). The computing device (e.g., wireless device) may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The computing device may communicate with a wireless node (e.g., BS 102, mmW BS 180, core network 170 of FIG. 1, core network 320 of FIG. 3, SMO Framework 305 of FIG. 3, O-eNB 311 of FIG. 3, RIC 325 of FIG. 3, O-Cloud 390 of FIG. 3, CU 310 of FIG. 3, DU 330 of FIG. 3, AS security anchor 512, 518 of FIG. 5, AS security anchor 608 of FIG. 6, AS security anchor 708 of FIG. 7, AS security anchor 808 of FIG. 8, computing system 1100 of FIG. 11, etc.) of a wireless system. The operations of the process 1000 may be implemented as software components that are executed and run on one or more processors (e.g., processor 1110 of FIG. 11 or other processor(s)). Further, the transmission and reception of signals by the wireless network (or component of the wireless network, such as the security service) in the process 1000 may be enabled, for example, by one or more antennas (e.g., antennas 252 of FIG. 2) and/or one or more transceivers (e.g., modulators/demodulators 254, TX MIMO processor 266, MIMO detector 256, transmit processor 264, receive processor 258 of FIG. 2, etc.).

At block 1002, the computing device (or component thereof) may receive a wireless node key for a wireless node, of a set of wireless nodes. In some cases, the wireless node key is generated from an access stratum (AS) security anchor key (e.g., AS security anchor key 510 (K_{CUA}), AS security anchor key 520 (K_{CUA}) of FIG. 5, etc.) of the AS security anchor (e.g., AS security anchor 608, which may be collocated with the security service 610 of FIG. 6, AS security anchor 708, which may be collocated with the security service 710 of FIG. 7, AS security anchor 808 of FIG. 8, etc.). In some examples, the wireless node key is received in advance of a mobility event. For example, wireless node keys may be provided to CUs of the set of CUs in advance of a mobility event where the UE is switching CUs, or the wireless node keys may be provided on demand. In some cases, the AS security anchor key is generated based on a security service key (e.g., security service key 506 (K_{SecSvc})) of a security service (e.g., security service 508 of FIG. 5, security service 610 of FIG. 6, security service 710 of FIG. 7, security service 810 of FIG. 8) of the wireless network. In some examples, the AS security anchor key is further generated based on an AS security anchor key index, a freshness parameter, and an invalidation parameter. In some cases, the AS security anchor key index is incremented in response to the generation of the AS security anchor key. In some examples, the freshness parameter comprises an uplink freshness parameter and a downlink freshness parameter, and wherein a type of the freshness parameter is based on whether generation of the AS security anchor key is initiated by a wireless device or by the wireless network. In some cases, at least one of the uplink freshness parameter or downlink freshness parameter is based on a fixed value. In some examples, the type of the freshness parameter is further based on a connection state of the wireless device. In some cases, the wireless node key is further generated based on a key identifier, a channel binding frequency, and a freshness parameter. In some examples, the key identifier comprises an identifier for a wireless node concatenated with a wireless node key index, and wherein the wireless node key index is incremented based on establishing the secure connection between the wireless node and a wireless device. In some cases, the wireless node key index is incremented for the set of wireless nodes based on establishing the secure connection between the wireless node and the wireless device.

At block 1004, the computing device (or component thereof) may switch to a target wireless node. In some cases, the computing device (or component thereof) may switch to the target wireless node based on an indication to switch. For example, the UE may receive an indication of the set of CUs and the UE may determine to switch to the second CU absent explicit signaling to perform the handover from the wireless network. As another example, the UE may receive an indication from the wireless network to switch to the second CU.

At block 1006, the computing device (or component thereof) may establish a secure connection (e.g., establishing 620 AS security context 622 of FIG. 7, establishing AS security context 722 of FIG. 7, establishing 836 AS security context 838 of FIG. 8, etc.) with the target wireless node based on the wireless node key.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 900, process 1000, and/or other processes described herein may include a processor, microprocessor, micro-computer, or other component of a device that is configured to carry out the steps of the process 900, process 1000, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 900, process 1000, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The processes 900 and 1000 are illustrated as a logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 900, process 1000, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present technology. In particular, FIG. 11 illustrates an example of computing system 1100, which may be for example any computing device making up internal computing system, a remote computing system, a camera, or any component thereof in which the components of the system are in communication with each other using connection 1105. Connection 1105 may be a physical connection using a bus, or a direct connection into processor 1110, such as in a chipset architecture. Connection 1105 may also be a virtual connection, networked connection, or logical connection.

In some embodiments, computing system 1100 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1100 includes at least one processing unit (CPU or processor) 1110 and connection 1105 that communicatively couples various system components including system memory 1115, such as read-only memory (ROM) 1120 and random access memory (RAM) 1125 to processor 1110. Computing system 1100 may include a cache 1112 of high-speed memory connected directly with, in close proximity to, or integrated as part of processor 1110.

Processor 1110 may include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which may represent any number of input mechanisms, such as a microphone for speech, a touch-sensitive screen for gesture or graphical input, keyboard, mouse, motion input, speech, etc. Computing system 1100 may also include output device 1135, which may be one or more of a number of output mechanisms. In some instances, multimodal systems may enable a user to provide multiple types of input/output to communicate with computing system 1100.

Computing system 1100 may include communications interface 1140, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 may include software services, servers, services, etc., that when the code that defines such software is executed by the processor 1110, it causes the system to perform a function. In some embodiments, a hardware service that performs a particular function may include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:
Aspect 1. An apparatus for accessing a wireless network, comprising: a memory system comprising instructions; and a processor system coupled to the memory system, wherein the processor system is configured to: receive, by an access stratum (AS) security anchor, a service key request for a set of wireless nodes; generate, based on an AS security anchor key of the AS security anchor, a wireless node key for a wireless node, of the set of wireless nodes; and transmit the wireless node key to the wireless node, wherein the wireless node key is for establishing a secure connection between the wireless node and a wireless device.
Aspect 2. The apparatus of Aspect 1, wherein the wireless node key is transmitted to the wireless node in advance of a mobility event from the wireless device.
Aspect 3. The apparatus of any of Aspects 1-2, wherein the AS security anchor key is generated based on a security service key of a security service of the wireless network.
Aspect 4. The apparatus of Aspect 3, wherein the AS security anchor key is further generated based on an AS security anchor key index, a freshness parameter, and an invalidation parameter.
Aspect 5. The apparatus of Aspect 4, wherein the AS security anchor key index is incremented in response to the generation of the AS security anchor key.
Aspect 6. The apparatus of Aspect 5, wherein the freshness parameter comprises at least one of an uplink freshness parameter or a downlink freshness parameter, and wherein a type of the freshness parameter is based on whether generation of the AS security anchor key is initiated by a wireless device or by the wireless network.
Aspect 7. The apparatus of Aspect 6, wherein at least one of the uplink freshness parameter or downlink freshness parameter is based on a fixed value.
Aspect 8. The apparatus of any of Aspects 6-7, wherein the type of the freshness parameter is further based on a connection state of the wireless device.
Aspect 9. The apparatus of any of Aspects 1-8, wherein the wireless node key is further generated based on a key identifier, a channel binding frequency, and a freshness parameter.
Aspect 10. The apparatus of Aspect 9, wherein the key identifier comprises an identifier for a wireless node concatenated with a wireless node key index, and wherein the wireless node key index is incremented based on establishing the secure connection between the wireless node and the wireless device.
Aspect 11. The apparatus of Aspect 10, wherein the wireless node key index is incremented for the set of wireless nodes based on establishing the secure connection between the wireless node and the wireless device.
Aspect 12. An apparatus for accessing a wireless network, comprising: a memory system comprising instructions; and a processor system coupled to the memory system, wherein the processor system is configured to: receive a wireless node key for a wireless node, of a set of wireless nodes, wherein the wireless node key is generated from an access stratum (AS) security anchor key of the AS security anchor; switch to a target wireless node; and establish a secure connection with the target wireless node based on the wireless node key.
Aspect 13. The apparatus of Aspect 12, wherein the wireless node key is received in advance of a mobility event.
Aspect 14. The apparatus of any of Aspects 12-13, wherein the AS security anchor key is generated based on a security service key of a security service of the wireless network.
Aspect 15. The apparatus of Aspect 14, wherein the AS security anchor key is further generated based on an AS security anchor key index, a freshness parameter, and an invalidation parameter.
Aspect 16. The apparatus of Aspect 15, wherein the AS security anchor key index is incremented in response to the generation of the AS security anchor key.
Aspect 17. The apparatus of Aspect 16, wherein the freshness parameter comprises an uplink freshness parameter and a downlink freshness parameter, and wherein a type of the freshness parameter is based on whether generation of the AS security anchor key is initiated by a wireless device or by the wireless network.
Aspect 18. The apparatus of Aspect 17, wherein at least one of the uplink freshness parameter or downlink freshness parameter is based on a fixed value.
Aspect 19. The apparatus of any of Aspects 17-18, wherein the type of the freshness parameter is further based on a connection state of the wireless device.
Aspect 20. The apparatus of any of Aspects 12-19, wherein the wireless node key is further generated based on a key identifier, a channel binding frequency, and a freshness parameter.
Aspect 21. The apparatus of Aspect 20, wherein the key identifier comprises an identifier for a wireless node concatenated with a wireless node key index, and wherein the wireless node key index is incremented based on establishing the secure connection between the wireless node and a wireless device.
Aspect 22. The apparatus of Aspect 21, wherein the wireless node key index is incremented for the set of wireless nodes based on establishing the secure connection between the wireless node and the wireless device.
Aspect 23. A method for accessing a wireless network, comprising: receiving, by an access stratum (AS) security anchor, a service key request for a set of wireless nodes; generating, based on an AS security anchor key of the AS security anchor, a wireless node key for a wireless node, of the set of wireless nodes; and transmitting the wireless node key to the wireless node, wherein the wireless node key is for establishing a secure connection between the wireless node and a wireless device.
Aspect 24. The method of Aspect 23, wherein the wireless node key is transmitted to the wireless node in advance of a mobility event from the wireless device.
Aspect 25. The method of any of Aspects 23-24, wherein the AS security anchor key is generated based on a security service key of a security service of the wireless network.
Aspect 26. The method of Aspect 25, wherein the AS security anchor key is further generated based on an AS security anchor key index, a freshness parameter, and an invalidation parameter.
Aspect 27. The method of Aspect 26, wherein the AS security anchor key index is incremented in response to the generation of the AS security anchor key.
Aspect 28. The method of Aspect 27, wherein the freshness parameter comprises an uplink freshness parameter or a downlink freshness parameter, and wherein a type of the freshness parameter is based on whether generation of the AS security anchor key is initiated by a wireless device or by the wireless network.
Aspect 29. The method of Aspect 28, wherein at least one of the uplink freshness parameter or downlink freshness parameter is based on a fixed value.
Aspect 30. The method of any of Aspects 28-29, wherein the type of the freshness parameter is further based on a connection state of the wireless device.
Aspect 31. The method of any of Aspects 23-30, wherein the wireless node key is further generated based on a key identifier, a channel binding frequency, and freshness parameter.
Aspect 32. The method of Aspect 31, wherein the key identifier comprises an identifier for a wireless node concatenated with a wireless node key index, and wherein the wireless node key index is incremented based on establishing the secure connection between the wireless node and the wireless device.
Aspect 33. The method of Aspect 32, wherein the wireless node key index is incremented for the set of wireless nodes based on establishing the secure connection between the wireless node and the wireless device.
Aspect 34. A method for accessing a wireless network, comprising: receiving a wireless node key for a wireless node, of a set of wireless nodes, wherein the wireless node key is generated from an access stratum (AS) security anchor key of the AS security anchor; switching to a target wireless node; and establishing a secure connection with the target wireless node based on the wireless node key.
Aspect 35. The method of Aspect 34, wherein the wireless node key is received in advance of a mobility event.
Aspect 36. The method of any of Aspects 34-25, wherein the AS security anchor key is generated based on a security service key of a security service of the wireless network.
Aspect 37. The method of Aspect 36, wherein the AS security anchor key is further generated based on an AS security anchor key index, a freshness parameter, and an invalidation parameter.
Aspect 38. The method of Aspect 37, wherein the AS security anchor key index is incremented in response to the generation of the AS security anchor key.
Aspect 39. The method of Aspect 38, wherein the freshness parameter comprises an uplink freshness parameter or a downlink freshness parameter, and wherein a type of the freshness parameter is based on whether generation of the AS security anchor key is initiated by a wireless device or by the wireless network.
Aspect 40. The method of Aspect 39, wherein at least one of the uplink freshness parameter or downlink freshness parameter is based on a fixed value.
Aspect 41. The method of any of Aspects 39-40, wherein the type of the freshness parameter is further based on a connection state of the wireless device.
Aspect 42. The method of any of Aspects 34-41, wherein the wireless node key is further generated based on a key identifier, a channel binding frequency, and a freshness parameter.
Aspect 43. The method of Aspect 42, wherein the key identifier comprises an identifier for a wireless node concatenated with a wireless node key index, and wherein the wireless node key index is incremented based on establishing the secure connection between the wireless node and a wireless device.
Aspect 44. The method of Aspect 43, wherein the wireless node key index is incremented for the set of wireless nodes based on establishing the secure connection between the wireless node and the wireless device.
Aspect 45. A non-transitory computer-readable medium having stored thereon instructions that, when executed by at least one processor, cause the at least one processor to perform operations according to any of Aspects 23-33.
Aspect 46. An apparatus for wireless communications comprising one or more means for performing operations according to any of Aspects 23-33.
Aspect 47. A non-transitory computer-readable medium having stored thereon instructions that, when executed by at least one processor, cause the at least one processor to perform operations according to any of Aspects 34-44.
Aspect 48. An apparatus for wireless communications comprising one or more means for performing operations according to any of Aspects 34-44.

What is claimed is:

1. An apparatus for accessing a wireless network, comprising:
a memory system comprising instructions; and
a processor system coupled to the memory system, wherein the processor system is configured to:
receive, by an access stratum (AS) security anchor, a service key request for a set of wireless nodes;
generate, based on an AS security anchor key of the AS security anchor, a wireless node key for a wireless node, of the set of wireless nodes; and
transmit the wireless node key to the wireless node, wherein the wireless node key is for establishing a secure connection between the wireless node and a wireless device.

2. The apparatus of claim 1, wherein the wireless node key is transmitted to the wireless node in advance of a mobility event from the wireless device.

3. The apparatus of claim 1, wherein the AS security anchor key is generated based on a security service key of a security service of the wireless network.

4. The apparatus of claim 3, wherein the AS security anchor key is further generated based on an AS security anchor key index, a freshness parameter, and an invalidation parameter.

5. The apparatus of claim 4, wherein the AS security anchor key index is incremented in response to the generation of the AS security anchor key.

6. The apparatus of claim 5, wherein the freshness parameter comprise at least one of an uplink freshness parameter or a downlink freshness parameter, and wherein a type of the freshness parameter is based on whether generation of the AS security anchor key is initiated by a wireless device or by the wireless network.

7. The apparatus of claim 6, wherein at least one of the uplink freshness parameter or downlink freshness parameter is based on a fixed value.

8. The apparatus of claim 6, wherein the type of the freshness parameter is further based on a connection state of the wireless device.

9. The apparatus of claim 1, wherein the wireless node key is further generated based on a key identifier, a channel binding frequency, and a freshness parameter.

10. The apparatus of claim 9, wherein the key identifier comprises an identifier for a wireless node concatenated with a wireless node key index, and wherein the wireless node key index is incremented based on establishing the secure connection between the wireless node and the wireless device.

11. The apparatus of claim 10, wherein the wireless node key index is incremented for the set of wireless nodes based on establishing the secure connection between the wireless node and the wireless device.

12. An apparatus for accessing a wireless network, comprising:
a memory system comprising instructions; and
a processor system coupled to the memory system, wherein the processor system is configured to:
receive a wireless node key for a wireless node, of a set of wireless nodes, wherein the wireless node key is generated from an access stratum (AS) security anchor key of the AS security anchor;
switch to a target wireless node; and
establish a secure connection with the target wireless node based on the wireless node key.

13. The apparatus of claim 12, wherein the wireless node key is received in advance of a mobility event.

14. The apparatus of claim 12, wherein the AS security anchor key is generated based on a security service key of a security service of the wireless network.

15. The apparatus of claim 14, wherein the AS security anchor key is further generated based on an AS security anchor key index, a freshness parameter, and an invalidation parameter.

16. The apparatus of claim 15, wherein the AS security anchor key index is incremented in response to the generation of the AS security anchor key.

17. The apparatus of claim 16, wherein the freshness parameter comprises an uplink freshness parameter and a downlink freshness parameter, and wherein a type of the freshness parameter is based on whether generation of the AS security anchor key is initiated by a wireless device or by the wireless network.

18. The apparatus of claim 17, wherein at least one of the uplink freshness parameter or downlink freshness parameter is based on a fixed value.

19. The apparatus of claim 17, wherein the type of the freshness parameter is further based on a connection state of the wireless device.

20. The apparatus of claim 12, wherein the wireless node key is further generated based on a key identifier, a channel binding frequency, and a freshness parameter.

21. The apparatus of claim 20, wherein the key identifier comprises an identifier for a wireless node concatenated with a wireless node key index, and wherein the wireless node key index is incremented based on establishing the secure connection between the wireless node and a wireless device.

22. The apparatus of claim 21, wherein the wireless node key index is incremented for the set of wireless nodes based on establishing the secure connection between the wireless node and the wireless device.

23. A method for accessing a wireless network, comprising:
receiving, by an access stratum (AS) security anchor, a service key request for a set of wireless nodes;
generating, based on an AS security anchor key of the AS security anchor, a wireless node key for a wireless node, of the set of wireless nodes; and
transmitting the wireless node key to the wireless node, wherein the wireless node key is for establishing a secure connection between the wireless node and a wireless device.

24. The method of claim 23, wherein the wireless node key is transmitted to the wireless node in advance of a mobility event from the wireless device.

25. The method of claim 23, wherein the AS security anchor key is generated based on a security service key of a security service of the wireless network.

26. The method of claim 25, wherein the AS security anchor key is further generated based on an AS security anchor key index, a freshness parameter, and an invalidation parameter.

27. The method of claim 26, wherein the AS security anchor key index is incremented in response to the generation of the AS security anchor key.

28. The method of claim 27, wherein the freshness parameter comprises an uplink freshness parameter or a downlink freshness parameter, and wherein a type of the freshness parameter is based on whether generation of the AS security anchor key is initiated by a wireless device or by the wireless network.

29. The method of claim 28, wherein at least one of the uplink freshness parameter or downlink freshness parameter is based on a fixed value.

30. The method of claim 28, wherein the type of the freshness parameter is further based on a connection state of the wireless device.
